(19) United States
(12) Patent Application Publication
(10) Pub. No.: US 2005/0229562 A1
(43) Pub. Date: Oct. 20, 2005

(54) Chemical filtration unit incorporating air transportation device

(76) Inventors: Andrew James Dallas, Apple Valley, MN (US); Lefei Ding, Falcon Heights, MN (US); Jon Dennis Joriman, Little Canada, MN (US); Jonathan George Parsons, Lino Lakes, MN (US)

Correspondence Address: MERCHANT & GOULD PC, P.O. BOX 2903, MINNEAPOLIS, MN, 55402-0903, US

(21) Appl. No.: 11/103,731

(22) Filed: Apr. 12, 2005

Related U.S. Application Data
(60) Provisional application No. 60/562,864, filed on Apr. 16, 2004.

(51) Int. Cl. B01D 46/00

(52) U.S. Cl. 55/486; 55/467

(57) ABSTRACT

The present invention overcomes the limits of activated carbons, ion exchange resin beads and fibers, and liquid form ion exchangers for acid, base, or VOCs gases removal by providing a filtration assembly for the filtration of chemical contaminants and particulates from an air or gas stream, the assembly having a low pressure-drop structure. The filtration assembly includes a low-pressure drop chemical filter, a low-pressure drop particulate filter, and an air transportation device, such as a fan or blower, all combined in a housing.

Priority under 35 U.S.C. §119(e) is claimed to U.S. provisional application No. 60/562,864, filed Apr. 16, 2004. The complete disclosure of provisional application No. 60/562,864 is incorporated herein by reference.

### FIELD OF THE DISCLOSURE

The present disclosure is related to air filtering systems for removing contaminants, particularly chemical contaminants such as acids, bases, or VOC gases from a gas stream, such as an air stream. The air filtering systems are particularly adapted for removing contaminants from air streams having a low level (<100 ppm) of contaminant.

### BACKGROUND

Filters and filtration systems that include activated carbons are widely used to remove VOCs from an air stream. The carbons can be modified with acids or bases to remove base or acid gases. The chemical contaminants, such as the VOCs, base contaminants and acid contaminants, are either adsorbed or absorbed by the carbon material. These adsorption materials are typically used in packed bed form with high pressure drop, high final product weight, and slow reaction mechanism. Examples of granular adsorption beds include those taught in U.S. Pat. No. 5,290,345 (Osendorf et al.), U.S. Pat. No. 5,964,927 (Graham et al.), U.S. Pat. No. 6,113,674 (Graham et al.) and U.S. Pat. No. 6,533,847 (Sequin et al.). These tightly packed beds result in a torturous path for air flowing through the bed

Ion exchange resin beads have improved capacity and faster reaction mechanism over modified activated carbons for acid or base gases removal, but ion exchange resin beads are also used in packed bed form, thus resulting in high pressure drop and high final product weight.

Another type of ion exchange material is perfluorinated polymers. One particular material, made from perfluorocarbonsulfonic acid based ionomers, is commercially available as “Nafion” and is available in a liquid or membrane form. These forms, however, do not allow for flexible filter designs.

The present invention overcomes the limits of activated carbons, ion exchange resin beads, and liquid form ion exchangers for removal of acid, base, or VOCs gases.

### SUMMARY OF THE DISCLOSURE

The present invention overcomes the limits of activated carbons, ion exchange resin beads, and liquid form ion exchangers for acid, base, or VOCs gases removal by providing a filtration assembly for the filtration of chemical contaminants and particulates from an air or gas stream, the assembly having a low pressure-drop. The filtration assembly includes a low-pressure drop chemical filter, a low-pressure drop particulate filter, and an air transportation device, such as a fan or blower, all combined in a housing.

The low pressure-drop chemical filter can be obtained by packing a thin layer of large size granular, beaded, pelleted, or cylindrical adsorption media. Alternately, the low pressure-drop can be obtained with a fibrous media having passages therethrough, the passages having a reactive coating or ion exchange coating thereon. Either embodiment includes a chemical contaminant removal material that has a fast reaction mechanism for removal of the chemical contaminant. Use of low-pressure drop chemical filters allows for removal of multiple contaminants from the same gas stream by stacking or layering different chemical filters.

The low-pressure drop particulate filter is a fibrous media, preferably a HEPA-type media.

By having a low-pressure drop chemical filter and particulate filter, according to this disclosure, the overall assembly weight, cost, and pressure drop through the assembly is significantly lowered, compared to if other, convention filters were used. Additionally, the energy used to move the air or gas stream through the assembly is less.

### BRIEF DESCRIPTION OF THE DRAWING

FIG. 1 is a schematic cross-section of a first embodiment of a filtration assembly according to the present disclosure.

FIG. 2 is a schematic cross-section of a second embodiment of a filtration assembly according to the present disclosure.

FIG. 3 is a schematic, perspective view of a first embodiment of a chemical filter for use in the assembly of the present disclosure.

FIG. 4 is a schematic, perspective view of a second embodiment of a chemical filter for use in the assembly of the present disclosure.

### DETAILED DESCRIPTION

This invention is directed to filtrations assemblies for the removal of low concentration (<100 ppm) of acid, base, or VOCs gases from a moving air steam using a low pressure-drop chemical filter. The contaminated air stream is directed through the filtration assembly by any air transport equipment such as fans, blowers, compressors, vacuum pumps, etc. The air or gas flow is directed through one or multiple low-pressure drop chemical filters and through one or more particulate filters. This filtration assembly is designed to be effective for acid, base, or VOCs gases removal, with low pressure-drop therethrough, and is lightweight.

The application of the filtration assembly of the present disclosure is quite broad and benefits from it can be realized in any situation that requires the removal of acid, base or VOCs gases at relatively low inlet concentrations (<100 ppm). The application environment may consist of a flowing air stream that is either dry or contains significant amounts of moisture.

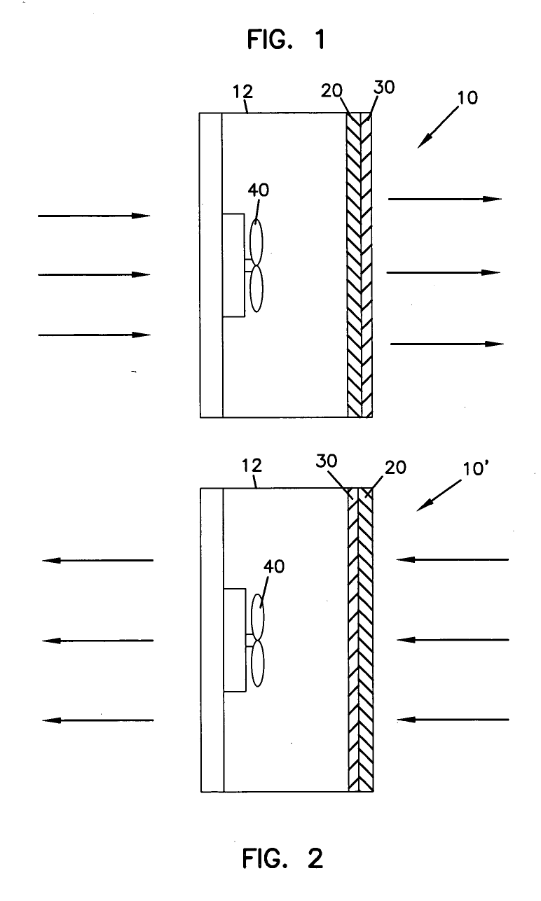

Referring to the figures, where like reference numerals throughout the figures refer to the same element, a filtration assembly 10 is illustrated in FIG. 1. Filtration assembly 10 has a housing 12 in which is positioned a low-pressure drop chemical filter 20, a low-pressure drop particulate filter 30, and air moving equipment 40, such as a fan.

In FIG. 1, fan 40 pulls air or other gas to be filtered into assembly 10, and pushes the air or gas through chemical filter 20 and particulate filter 30. In the configuration illustrated, chemical filter 20 is upstream of particulate filter 30; in alternate embodiments, particulate filter 30 may be upstream of chemical filter 20. In most configurations, however, it is preferred to have particulate filter 30 downstream of chemical filter 20, to catch any material that may be released from chemical filter 20.

A second embodiment of a filtration assembly 10′ is illustrated in FIG. 2. Similar to the embodiment of FIG. 1, filtration assembly 10′ has housing 12 in which is positioned low-pressure drop chemical filter 20, low-pressure drop particulate filter 30, and air moving equipment 40, such as fan.

In FIG. 2, fan 40 pulls air or other gas to be filtered into assembly 10 through chemical filter 20 and particulate filter 30. In the configuration illustrated, chemical filter 20 is upstream of particulate filter 30; in alternate embodiments, particulate filter 30 may be upstream of chemical filter 20.

It is preferred that the pressure drop through the combination of chemical filter 20 and particulate filter 30 is no greater than 2 inch water at an airflow filter face velocity of 0.5 m/s. Preferably, the pressure drop is no greater than 1 inch water at an airflow filter face velocity of 0.5 m/s, and even more preferably no greater than 0.5 inch water at an airflow filter face velocity of 0.5 m/s. In some embodiments, a pressure drop of no greater than 0.25 inch and even no greater than 0.2 inch is obtained.

Chemical Filter

Chemical filter 20 is a thin layer of a low pressure-drop, lightweight, high-efficiency chemical filter. Chemical filter 20 can be used for the removal of acid, base, or volatile organics (VOCs) gases from flowing air streams. Concurrent removal of acid, base, or VOCs gases from the air stream can be achieved by placing multiple layers in series to form chemical filter 20.

By use of the term “low-pressure drop” and variations thereof, what is intended is that the pressure drop through chemical filter 20 is no greater than 1 inch water at an airflow filter face velocity of 0.5 m/s. Preferably, the pressure drop is no greater than 0.5 inch water at an airflow filter face velocity of 0.5 m/s, and even more preferably no greater than 0.1 inch water at an airflow filter face velocity of 0.5 m/s. It is preferred that chemical filter 20 has “straight-through” or “in-line” flow therethrough.

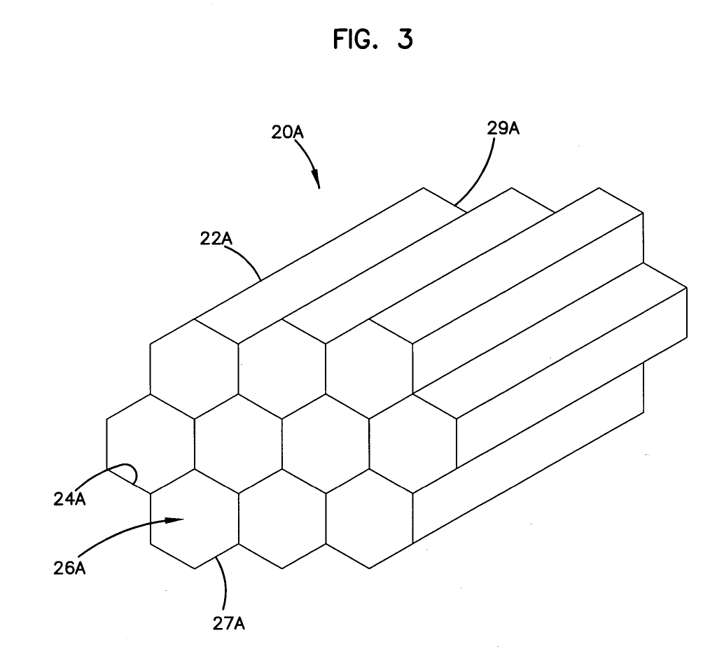

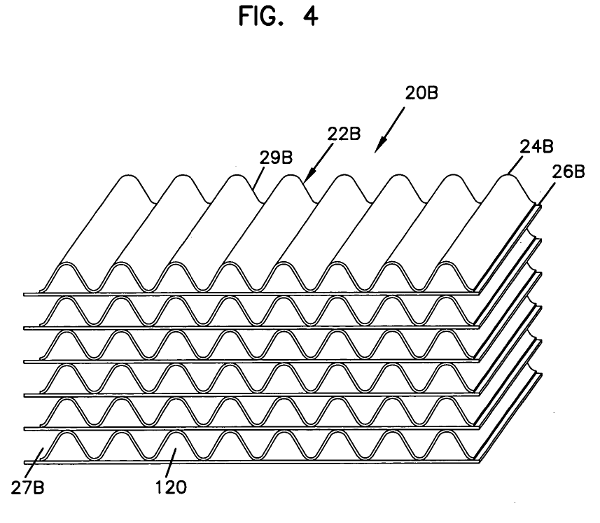

Referring now to the figures, specifically to FIG. 3, a first embodiment of a low-pressure drop chemical filter 20 is shown at 20A. Such a chemical filter is described in U.S. Pat. No. 6,645,271, which is incorporated herein by reference in its entirety. Chemical filter 20A is defined by a structured body 22A having a first face 27A and a second face 29A. Body 22A includes a plurality of cells 24A therein. Preferably, cells 24A are present in a non-random, orderly array. Cells 24A define passages 26A through body 22A that extend from first face 27A to second face 29A. Filter 20A has “straight-through flow” or “in-line flow”, meaning that gas to be filtered enters in one direction through first face 27A and exits in generally the same direction from second face 29A. Present on the interior walls of cells 24A is an adsorptive coating that has an adsorptive media retained on cells 24A by a polymeric resin or adhesive. The coating is present within cells 24A yet allows air or other fluid to move through passages 26A.

The adsorptive coating, specifically the adsorptive media, removes contaminants from the air passing through passages 26A by adsorbing, absorbing, trapping, retaining, reacting, or otherwise removing contaminants from the air stream. An adsorptive media such as activated carbon, traps contaminants on its surface or in its pores. Depending on the size of the contaminants and the porosity of the adsorptive media, some contaminants may enter into and become trapped within pores or passages within the adsorptive media. Typically, the surfaces of the adsorptive media react with the contaminants, thus adsorbing the contaminants at least on the surfaces. The coating can additionally or alternately have an oxidizing agent. When heat is applied, volatile organic compounds (VOCs) that contact the coating are oxidized into carbon dioxide and water.

Examples of suitable adsorptive medias or materials for use in chemical filter 20A include activated carbons, ion exchange resins, catalysts, inorganic chemical adsorbents such as carbonates, soda lime, silica gel, activated alumina and molecular sieve. These chemical filtration media can be modified to target various contaminants and they come in various forms such as granular, beaded, cylinders, powder, or fibers.

The activated carbon can be coconut, wood, pitch or carbonaceous polymer based, and come in various forms such as granular, beaded, cylindrical, powdered, or as activated carbon fiber (ACFs). The material used can be virgin carbons or carbon fibers to remove VOCs or modified with acids or bases to remove base or acid gases.

Ion exchange resins are typically in bead form and include basic anion and acidic cation resins, although liquid forms are known (such as “Nafion”). Fiber form ion exchangers include nonwoven needle punched ion exchange fibers with functional groups on synthetic polymer fibers. The substrates or matrices include industrial fibers such as polypropylene (PP) fibers or polyacrylic fibers. The polypropylene industrial fibers are modified by radiochemical grafting of polystyrene (ST) or its co-polymer divinylbenzene (DVB). The PP-ST-DVB matrices can be used for the preparation of a variety of ion exchangers such as sulfonic, carboxylic, and phosphoric acid cation exchangers and anion exchangers containing quaternary ammonium groups or ammonium chloride or hydroxide. The polyacrylic fibers can be used to incorporate carboxylic acid or strong base groups. Ion exchange fibers usually form tow, felt, yarn, nonwoven cloth or fabric structures. These fabric structures already offer lower pressure drop advantage. Further configurations such as fluting or pleating convert them into other low pressure-drop structures, such as body 22B, described below.

Ion exchange resins/fibers can be regenerated. For the H-form cation ion exchangers on low pressure-drop substrates, an amine-resin complex is formed upon reaction with gaseous bases such as ammonia or amines. The amines can be recovered by elution with caustic soda and finally regenerated by washing again with acids. The exhausted OH form strong anion ion exchangers on low pressure-drop substrates can be regenerated with concentrated sodium hydroxide, which converts them to the hydroxide form. The exhausted weak anion ion exchangers on low pressure-drop substrates can be regenerated with weakly basic reagents such as ammonia or sodium carbonate.

Catalysts can be used to accelerate the chemical adsorption between contaminants in the air or gas and another substance to provide either a nontoxic substance, such as carbon dioxide and water, or a substance that can be readily removed from air or retained on the catalysts. “Hopcalite” is such a catalyst that uses activated manganese and cupric oxides to effectively destroy acid gases and volatile organic compounds (VOCs) at low temperatures. Catalysts usually come in various forms such as granular, beaded and cylindrical.

Another family of chemical filtration media suitable for use in chemical filter 20 is inorganic adsorbents such as carbonates, soda lime, silica gel, activated alumina and molecular sieve. Carbonates and soda lime are used for the chemi-sorption of acid gas vapors such as hydrogen chloride, hydrogen fluoride, hydrogen sulfide, sulfur dioxide, nitric oxides, and carbon oxides. Silica gel adsorbs base gases and VOCs and can be modified with salts to remove acid gases. Activated alumina is used to remove acidic gas vapors and can be modified with salts to remove base gases. Molecular sieves are used to remove VOCs and can be modified with salts to remove acid or base gases. These inorganic adsorbents are usually available in the forms of granules, beaded and cylindrical.

A second embodiment of low-pressure drop chemical filter 20 is shown in FIG. 4 as 20B. Contaminant-removal filter 20B is defined by a fibrous body 22B having a first face 27B and an opposite second face 29B. Generally, air or gas to be cleansed enters filter 20B via first face 27B and exits via second face 29B. In this embodiment, body 22B is formed by alternating a corrugated layer 24B with a facing layer 26B. Corrugated layer 24B has a rounded wave formation, with each of the valleys and peaks being generally the same. Facing layer 26B can be a corrugated layer or a non-corrugated (e.g., flat) sheet; in this embodiment facing layer 26B is a flat sheet. Layer 24B and layer 26B together define a plurality of passages 120 through fibrous body 22B that extend from first face 27B to second face 29B. Filter 20B has “straight-through flow” or “in-line flow”, meaning that gas to be filtered enters in one direction through first face 27B and exits in generally the same direction from second face 29B.

Chemical filter 20B includes an adsorptive or reactive material either on or within fibrous body 22B. Examples of impregnated fibrous low-pressure drop filters are disclosed in U.S. patent application Ser. No. 10/928,776 (filed Aug. 27, 2004), Ser. No. 10/927,708 (filed Aug. 17, 2004), and Ser. No. 11/016,013 (filed Dec. 17, 2004), each of which is incorporated herein by reference. These applications are directed to chemical filter elements that use fibrous filtration media impregnated with various active ingredients, configured to adsorb, absorb or otherwise remove the desired contaminants, such as acid contaminants, base contaminants, and VOCs, including carbonyl-containing compounds. Air passes through these filter elements with generally straight-through flow. Various examples of such low pressure-drop filters are available from Donaldson Company under the designation “Wizard” filter elements. Examples of impregnants include ion exchange resins, catalysts, inorganic chemical adsorbents such as carbonates, soda lime, silica gel, and molecular sieve. These materials are generally coated on low pressure-drop substrates by either dissolving them in a solution and washing, or dipping, or spraying methods followed by a drying process.

Another embodiment of a low pressure-drop chemical filter 20 to reduce energy loss could be obtained by packing a thin layer of large size granular, beaded, cylindrical, fibrous, or the like adsorbent materials such as carbon, ion exchange media, catalyst, or inorganic absorbents between two thin layers of polymeric screens to form a sandwiched structure. Fibrous mats of ion exchange material could be formed into a panel filter, preferably supported by screen(s).

Particulate Filter

Particulate filter 30 is a low pressure-drop, lightweight, high-efficiency particulate filter, typically a thin layer of filter media. Particulate filter 30 preferably include HEPA media. HEPA filters are known in the art of filters as “high-efficiency particulate air” filters. HEPA media is the media of the filter that provides the filtration efficiency. HEPA media has a minimum efficiency of 99.97% removal when tested with essentially monodispersed 0.3 micron particles. The media for filter 30 may be any suitable media, either HEPA media or not, and may be made from cellulose, polymeric materials (e.g., viscose, polypropylene, polycarbonate, etc.), glass or fiberglass, or natural materials (e.g., cotton). Other filtration media materials are known. For example, microfibrous glass is a preferred material for HEPA media. The filtration media may be electrostatically treated and/or include one or more layers of material. One or more layers of fine fiber, such as taught by U.S. Pat. No. 4,650,506 (Barris et al.) or U.S. Pat. No. 6,673,136 (Gillingham et al.), may be included in particulate filter 30.

By use of the term “low-pressure drop” and variations thereof, what is intended is that the pressure drop through particulate filter 30 is no greater than 1 inch water at an airflow filter face velocity of 0.5 m/s. Preferably, the pressure drop is no greater than 0.5 inch water at an airflow filter face velocity of 0.5 m/s, and even more preferably no greater than 0.1 inch water at an airflow filter face velocity of 0.5 m/s.

Air Transport Equipment

Air transport equipment 40 is used to generate airflow through filtration assembly 10, 10′. Examples of air transport equipment 40 typically include fans, blowers, compressors, vacuum pumps, etc.

In FIG. 1, chemical filter 20 and particulate filter 30 are illustrated downstream or after air transport equipment 40, however, in FIG. 2, chemical filter 20 and particulate filter 30 are illustrated upstream or before air transport equipment 40; either configuration is suitable.

Housing

As described above and illustrated in FIGS. 1 and 2, each of chemical filter 20, particulate filter 30 and air transport equipment 40 are contained in housing 12. Housing 12 includes an inlet upstream of each of chemical filter 20, particulate filter 30 and air transport equipment 40 and an outlet downstream of each of chemical filter 20, particulate filter 30 and air transport equipment 40.

Exemplary Filtration Assemblies

A filtration assembly according to the present disclosure was made having an aluminum sheet metal housing, approximately 11.2 inches long, 7.45 inches high, and 7.75 inches wide. The two faces sized 7.45 by 7.75 were generally open, with only an 0.5 inch lip around the face circumference. Inside the housing was a chemical filter, made from an acid gas removal media (obtained from IMATEK under the designation Fiban AK22) that was 6.75 inches by 7.0 inches and 10 mm thick. Also inside the housing was a particulate filter, made from HEPA grade filtration media that was also 6.75 inches by 7.0 inches and 10 mm thick. The particulate filter was positioned exterior to the chemical filter. A fan (obtained from EBM Industries, model R1G133-AB41-52) which has a capacity of 0-202 cfm was also positioned in the housing. The chemical filter and particulate filter were held in place by lips or detents inside the housing.

The filtration assembly was arranged similar to FIG. 1 so that air was pulled into the assembly by the fan and then pushed through the chemical filter and then the particulate filter.

It was believed that the filter assembly provided an acceptable pressure drop therethrough. Although the fan in this example was not rated to provide the desired flow rate for the measurement, at a volume flow rate of 208 cfm, an airflow filter face velocity of 0.5 m/s would have been obtained. At an air flow rate of 200 cfm, a filter face velocity of 0.48 m/s is obtained.

An alternate filtration assembly is similar to that described immediately above, except that the particulate filter is a pleated panel filter having a thickness of about 2 inches with a screen on each face to provide support.

The foregoing description, which has been disclosed by way of the above discussion and the drawings, addresses embodiments of the present disclosure encompassing the principles of the present invention. The assembly maybe changed, modified and/or implemented using various types of equipment and arrangements. Those skilled in the art will readily recognize various modifications, configurations and changes which maybe made to the described equipment without strictly following the exemplary embodiments illustrated and described herein.

1. A filtration assembly comprising:
(a) a housing having an inlet and an outlet for defining an air flow path through the housing;
(b) a low-pressure drop chemical filter positioned in the housing between the inlet and the outlet in the air flow path;
(c) a low-pressure drop particulate filter positioned in the housing between the inlet and the outlet in the air flow path; and
(d) an air transport device positioned in the housing between the inlet and the outlet in the air flow.

2. The filtration assembly according to claim 1, wherein the low-pressure drop chemical filter is configured to provide a pressure drop of no greater than 0.5 inch water at an airflow filter face velocity of 0.5 m/s.

3. The filtration assembly according to claim 1, wherein the low-pressure drop chemical filter is configured to provide a pressure drop of no greater than 0.1 inch water at an airflow filter face velocity of 0.5 m/s.

4. The filtration assembly according to claim 1, wherein the low-pressure drop chemical filter is configured for straight-through flow.

5. The filtration assembly according to claim 1, wherein the chemical filter is configured for removal of at least one of acid contaminants, base contaminants and VOCs from the air flow path.

6. The filtration assembly according to claim 1, wherein the low-pressure drop particulate filter is configured to provide a pressure drop of no greater than 0.5 inch water at an airflow filter face velocity of 0.5 m/s.

7. The filtration assembly according to claim 1, wherein the low-pressure drop particulate filter comprises HEPA media.

8. The filtration assembly according to claim 1, wherein the particulate filter is positioned downstream of the chemical filter.

9. A filtration assembly comprising:
(a) a housing having an inlet and an outlet for defining an air flow path through the housing;
(b) a low-pressure drop chemical filter positioned in the housing between the inlet and the outlet in the air flow path, the chemical filter configured for straight-through flow and configured to provide a pressure drop of no greater than 0.5 inch water at an airflow filter face velocity of 0.5 m/s;
(c) a low-pressure drop particulate filter positioned in the housing between the inlet and the outlet in the air flow path, the particulate filter configured to provide a pressure drop of no greater than 0.5 inch water at an airflow filter face velocity of 0.5 m/s; and
(d) an air transport device positioned in the housing between the inlet and the outlet in the air flow.

10. A filtration assembly comprising:
(a) a housing having an inlet and an outlet for defining an air flow path through the housing;
(b) a low-pressure drop chemical filter positioned in the housing between the inlet and the outlet in the air flow path, the chemical filter configured for straight-through flow and configured to provide a pressure drop of no greater than 0.5 inch water at an airflow filter face velocity of 0.5 m/s, the chemical filter comprising:
(i) a first layer configured for removal of acidic contaminants; and
(ii) a second layer configured for removal of basic contaminants;
(c) a low-pressure drop particulate filter positioned in the housing between the inlet and the outlet in the air flow path, the particulate filter configured to provide a pressure drop of no greater than 0.5 inch water at an airflow filter face velocity of 0.5 m/s; and
(d) an air transport device positioned in the housing between the inlet and the outlet in the air flow.

11. The filtration assembly according to claim 10, wherein the chemical filter further comprises a third layer for removal of VOCs.
